(19) United States
(12) Patent Application Publication
(10) Pub. No.: US 2007/0289629 A1
(43) Pub. Date: Dec. 20, 2007

(54) Device and Method for Controlling the Flow Speed of a Fluid Flow in a Hydraulic Line

(76) Inventors: Uwe Iben, Gerlingen (DE); Klaus Habr, Marktheidenfeld (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/659,357

(22) PCT Filed: Jul. 18, 2005
(86) PCT No.: PCT/EP05/53463

§ 371 Date: Feb. 5, 2007

(30) Foreign Application Priority Data
Aug. 3, 2004 (DE) 102004037537.2

(51) Int. Cl. G05D 7/00

(52) U.S. Cl. 137/50; 137/3

(57) ABSTRACT

The invention relates to a device (1) for controlling the flow speed of a fluid flow in a hydraulic line (3) and has
a line segment (2) that permits the fluid to flow through as well as
an apparatus (4) for generating a homogenous two-phase mixture (5) in the fluid in the line segment (2).

### PRIOR ART

The invention relates to a device and method for controlling the flow speed of a fluid flow in a hydraulic line.

In a multitude of applications, it is necessary to control the speed of a fluid flow inside a hydraulic line, for example in order to set a desired flow speed and/or to eliminate or at least smooth undesirable pressure pulsations and/or to reflect pressure pulsations at least in one flow direction. Hydraulic systems in which the flow speed must be controlled in this manner are present, among other things, in motor vehicles, for example in fuel injection systems, a power steering system, and a brake system. In these highly dynamic systems, the elimination or smoothing of pressure pulsations is of particular importance.

Conventional control devices such as control valves function by means of changing the effective internal geometry in terms of flow mechanics. In other words, a control valve of this kind contains a valve element that can be moved between at least two positions. A conventional control valve therefore contains at least one physically movable component. In highly dynamic processes, a conventional control valve involving this kind of mechanics is subjected to powerful wear phenomena.

### ADVANTAGES OF THE INVENTION

The control device according to the invention with the defining characteristics of claim 1 and the control method according to the invention with the defining characteristics of claim 10 have the advantage over the prior art that no mechanical components are required in order to control the flow speed, i.e. no physically moving components are required. Consequently, the invention functions almost without wear. Moreover, a valve according to the invention does not require any moving parts, permitting implementation of extremely short switching times. This results in clear advantages for the control device and for a hydraulic system equipped with it.

The present invention is based on the general concept of producing a homogeneous two-phase mixture in a line segment provided for this purpose and setting the respective desired flow speed by varying the mass percentage of the gas phase in the two-phase mixture. In this connection, the invention makes use of the knowledge that within a homogeneous two-phase mixture, the speed of sound depends heavily on the mass percentage of the gas phase so that even very low mass percentages of the gas phase can suffice to significantly reduce the speed of sound of the two-phase mixture. For example, in a mixture of water and water vapor, the speed of sound of approximately 1400 m/s when the mixture contains no gas phase drops to approximately 16 m/s when the mixture contains a gas phase mass percentage of approximately 10⁻³. Also important for the invention is the consideration that the speed of sound of the two-phase mixture more or less represents the maximum achievable flow speed since supersonic flows result in extremely high shock losses.

In order to adjust a desired flow speed with the aid of the control device according to the invention, a two-phase mixture is thus intentionally produced in which the mass percentage of the gas phase is selected so that the resulting speed of sound of the two-phase mixture corresponds to the desired flow speed to be set.

In addition, a control device of this kind can be used in a particularly simple fashion to eliminate or at least smooth pressure pulsations. Because the mass percentage of the gas phase in the two-phase mixture, by means of the resulting speed of sound of the two-phase mixture, defines a maximum permissible flow speed through the line segment of the control device. Subsonic flow speeds can consequently pass through the line segment in a more or less undamped fashion, whereas supersonic flow speeds can be powerfully damped, i.e. significantly smoothed, by the extremely high shock losses. The desired smoothing or elimination occurs because pressure pulses have a locally excessive speed.

In a suitable fashion, the line segment can have a defined cross-sectional constriction or can itself represent a defined cross-sectional constriction within the hydraulic line. With the aid of such a cross-sectional constriction, it is possible to locally increase the flow speed in the fluid flow in the region of the control device inside the hydraulic line in order to thus more quickly arrive in the range of the speed of sound of the two-phase mixture even at lower flow speeds to the rest of the hydraulic line. It is thus advantageously possible to adapt the control device to the given control range.

In a modification, the two-phase mixture is suitably produced in the region of the cross-sectional constriction in order to be able to adjust the flow speed independently of the flow direction.

In another embodiment, the line segment adjoining the cross-sectional constriction can have a two-phase zone with an enlarged cross-section; the two-phase mixture is then produced in the region of this two-phase zone. In an embodiment of this kind, the control of the flow speed depends on the instantaneous flow direction. Initially, the mass content of the gas phase defines the maximum flow speed that can be set. If the two-phase zone is then situated downstream of the cross-sectional constriction, then it is in fact possible to set speeds within the cross-sectional constriction that exceed the speed of sound of the two-phase mixture. But if the two-phase zone is situated upstream of the cross-sectional constriction, then the fluid flow causes the two-phase mixture to also extend into the cross-sectional constriction. Since higher speeds are present there, the speed of sound of the two-phase mixture is reached much, much earlier so that in this flow direction, the control device already exerts its inhibiting or damping action at lower flow speeds in the rest of the hydraulic line. An embodiment of this kind can in particular achieve a direction-dependent reflection of pressure pulsations.

Other important defining characteristics and advantages of the present invention ensue from the dependent claims, the drawings, and the accompanying description of the figures.

### DRAWINGS

Exemplary embodiments of the invention are shown in the drawings and will be explained in detail below; components that are the same or are functionally equivalent have been provided with the same reference numerals.

All depictions are schematic in nature.

FIG. 1 shows a very simplified schematic representation of a half longitudinal section through a device according to the invention,

FIG. 2 shows a view similar to the one in FIG. 2, but of a different embodiment,

FIG. 3 shows a schematic representation similar to a wiring diagram of a preferred embodiment of the device according to the invention.

### DESCRIPTION OF THE EXEMPLARY EMBODIMENTS

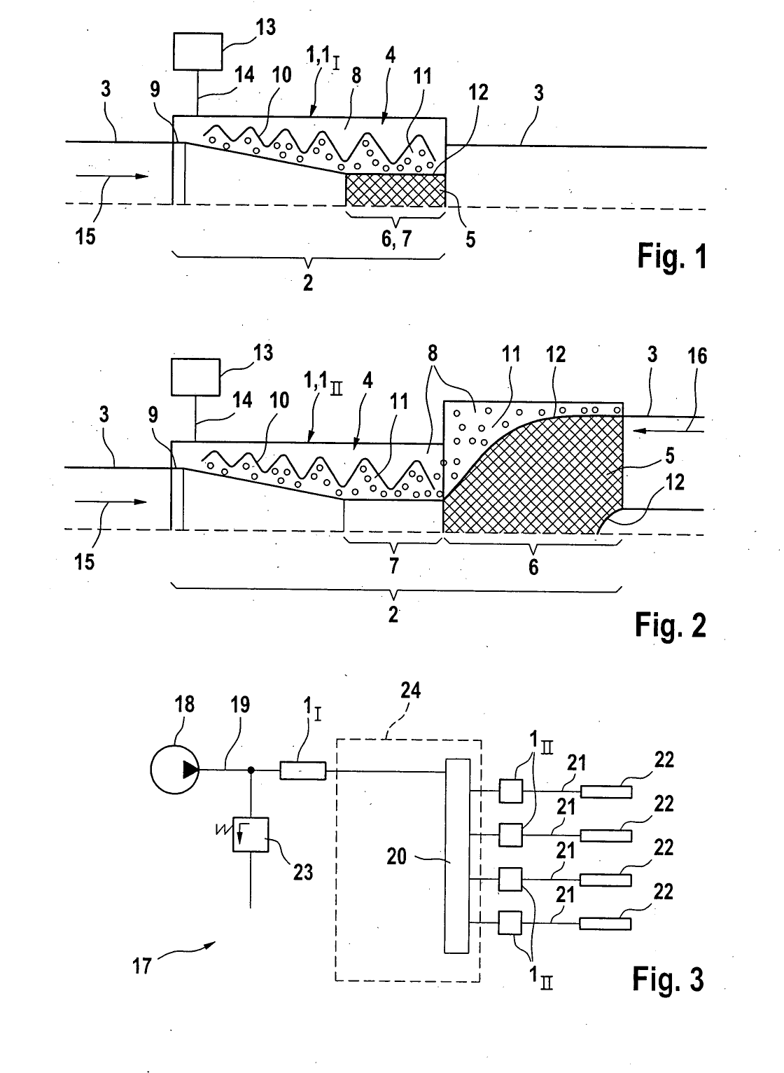

According to FIGS. 1 and 2, a control device 1 according to the invention has a line segment 2 through which a fluid can flow, which is indicated by a curly brace in the figures. When installed, the control device 1 is integrated into a hydraulic line 3, i.e. the line segment 2 constitutes a segment of the hydraulic line 3 so that the fluid transported in the hydraulic line 3 also flows through the line segment 2.

The control device 1 is also equipped with a generator apparatus 4, which makes it possible to produce a homogeneous two-phase mixture in the fluid in the line segment 2. The two-phase mixture formed in the generator apparatus 4 is symbolized in the figures by a crosshatching and is labeled with the reference numeral 5. In this way, during operation, the generator apparatus 4 forms a two-phase zone 6 inside the line segment 2, in which the two-phase mixture 5 is present and which is indicated by a curly brace and labeled with the reference numeral 6 in the figures.

In a suitable fashion, the line segment 2 inside the hydraulic line 3 constitutes a definite cross-sectional constriction. To this end, in the embodiments depicted here, the line segment 2 is equipped with a definite cross-sectional constriction 7 that is likewise indicated by a curly brace. The cross-sectional constriction 7 in the embodiment according to FIG. 1 coincides with the two-phase zone 6. This means that in this embodiment, the generator apparatus 4 produces the two-phase mixture 5 in the region of the cross-sectional constriction 7. By contrast, in the embodiment according to FIG. 2, the two-phase zone 6 and the cross-sectional constriction 7 are situated adjacent to each other in relation to the flow direction. In this instance, the two-phase zone 6 has an enlarged cross section in comparison to the cross-sectional constriction 7.

The homogeneous two-phase mixture 5 can be produced in essentially any way in the region of the two-phase zone 6. The embodiments explained below are therefore merely presented as illustrative examples and do not limit universal applicability.

In one useful embodiment, the generator apparatus 4 can produce the gas phase of the two-phase mixture 5 directly from the fluid phase of the fluid flow being transported in the hydraulic line 3. For example, the generator apparatus 4 can excite the fluid in the two-phase zone 6 in order to produce the gas phase, for example by correspondingly subjecting it to ultrasonic radiation or microwaves. In this case, the gas phase is generated directly in the fluid phase so that the homogeneous two-phase mixture 5 is produced directly in the fluid flow.

Alternatively, first a partial flow of the fluid can be diverted, which is then vaporized to produce the gas phase; the gas phase thus produced is then conveyed back to the fluid phase to produce the homogenous two-phase mixture 5.

According to FIGS. 1 and 2, the generator apparatus 4, for example, can be equipped with a bypass chamber 8 that communicates with the line segment 2 via a bypass 9. When a flow is passing through the line segment 2, it is thus possible to divert a partial flow via the bypass 9. In addition, the generator apparatus 4 is equipped with a heating unit 10 that is able to convert the fluid phase, which has been diverted into the bypass chamber 8, into the gas phase by generating heat. For example, the heating unit 10 is a resistance heating unit, e.g. in the form of a heating coil or the like, which is situated in the bypass chamber 8. Alternatively, the heating unit 10 can also function by means of microwaves, ultrasound waves, and/or infrared waves. The gas phase produced by the heating unit 10 is symbolized by small circles in FIGS. 1 and 2 and is labeled with the reference numeral 11.

So that the generator apparatus 4 is able to introduce the generated gas phase 11 into the two-phase zone 6 for the production of the homogenous two-phase mixture 5, in the embodiments shown here, the line segment 2 is equipped with a gas-permeable wall 12 in the vicinity of the two-phase zone 6. With a corresponding gas pressure in the bypass chamber 8, the gas phase 11 can permeate the gas-permeable wall 12, thus producing the two-phase mixture 5 in the two-phase zone 6. It is possible to achieve the required homogeneity of the two-phase mixture 5 through a suitable embodiment of the gas-permeable wall 12 and/or of the flow routing within the two-phase zone 6. For example, it is possible to make the wall 12 gas-permeable by embodying it in a perforated or porous form. For example, the wall is composed of a porous ceramic material or of a membrane that is permeable to gas, but impermeable to fluid.

The control device 1 according to the present invention serves to control the flow speed of a fluid flow in the hydraulic line 3. Since the line segment 2 within the hydraulic line 3 constitutes or contains the cross-sectional constriction 7, this determines the location of the greatest flow speed. The speed of sound of the pure fluid phase thus defines the maximum flow speed that can be set with the aid of the control device 1.

The invention is based on the knowledge that within the two-phase mixture 5, the speed of sound depends heavily on the mass percentage of the gas phase so that even a comparatively low mass percentage of the gas phase results in a significant reduction in the speed of sound. The minimum speed that can be set then defines the minimum flow speed that can be set with the aid of the control device 1.

In order to be able to set a desired flow speed in the fluid flow, the control device 1 is also equipped with a control unit 13, which actuates the generator apparatus 4 via a corresponding control line 14. The control unit 13 is designed so that it can vary the mass percentage of the gas phase in the two-phase mixture 5 depending on the desired flow speed. For example, the dependence of the speed of sound of the two-phase mixture 5 on the mass percentage of the gas phase is stored in the form of a characteristic curve or a mathematical formula in a memory in the control unit 13. Likewise, a control loop can be provided, whose control variable is the mass percentage of the gas phase and whose reference variable is the flow speed. By means of a desired/actual comparison of the flow speed, it is then possible to determine whether it is necessary to introduce more gas into the fluid in order to reduce the flow speed or whether it is necessary to throttle the introduction of the gas phase into the fluid phase in order to increase the flow speed.

The embodiment of the control device 1 in FIG. 1 is labeled with the reference numeral 1_{I} below and functions as follows:

The control device 1_{I} can, for example, be used to set a predetermined flow speed. To this end, the control unit 13 triggers the generator apparatus 4 so that a two-phase mixture 5 develops in the two-phase zone 6, whose speed of sound corresponds to the desired flow speed to be set. Then the fluid flow transported in the hydraulic line 3 can no longer exceed the set flow speed since it corresponds to the speed of sound in the two-phase mixture 5 so that extremely high shock resistances must be overcome in order to exceed the sound barrier.

In the embodiment in FIG. 1, the two-phase mixture 5 is produced in the cross-sectional constriction 7, i.e. the two-phase zone 6 is situated in the cross-sectional constriction 7. In this way, the control device 1_{I} functions independently of the flow direction, which is symbolized by an arrow and labeled with the reference numeral 15 in FIGS. 1 and 2. Since the greatest flow speed in the line segment 2 occurs in the cross-sectional constriction 7, it is particularly easy to reduce the speed of sound there with the aid of the two-phase mixture 5.

The control device 1_{I} can also be used to damp, smooth, or eliminate pressure pulsations. In a pressure pulse, a locally superelevated speed prevails, which with a correspondingly adjusted two-phase mixture 5, is greater than the speed of sound of the two-phase mixture 5. Correspondingly, an incoming pressure wave cannot pass through the two-phase phase zone 6 or is only able to do so in a significantly damped fashion. With the aid of a mass percentage of the gas phase in the two-phase mixture 5, the control unit 13 can thus set a limit speed up to which oscillations in the flow speed can be tolerated and only pressure pulses with a higher speed are damped.

If the control device 1_{I} simultaneously controls the flow speed inside the hydraulic line 3, then each pressure pulse produces a speed that exceeds the speed of sound of the two-phase mixture 5, thus permitting damping or elimination of every pressure pulse. The smoothing, damping, or elimination of pressure pulses in the embodiment of the control device 1_{I} in FIG. 1 is independent of the flow direction since the two-phase zone 6 is situated in the cross-sectional constriction 7.

The embodiment of the control device 1 in FIG. 1 is labeled with the reference numeral 1_{II} and will be described in detail below:

The essential differences between the control device 1_{II} according to FIG. 2 and the control device 1_{I} according to FIG. 1 are on the one hand, the separation of the two-phase zone 6 from the cross-sectional constriction 7 and on the other hand, the enlarged cross section of the two-phase zone 6 in relation to the cross-sectional constriction 7. By means of its design, the control device 1_{II} functions in a manner that is dependent on the flow direction.

For example, the control unit 13 sets a particular mass percentage of the gas phase in the two-phase mixture 5. This results in a particular speed of sound, which defines the maximum flow speed in the hydraulic line 3.

In the flow direction 15 shown in FIG. 2 (from left to right), the two-phase mixture 5 is situated in the two-phase zone 6 and, due to the entraining action of the flow, also downstream of it in the hydraulic line 3. In an opposite flow direction (from right to left), which is symbolized in FIG. 2 by an arrow 16, the entraining action of the flow causes two-phase mixture 5 to travel from the two-phase zone 6 into the cross-sectional constriction 7. Since a significantly higher flow speed occurs in the cross-sectional constriction 7 than in the two-phase zone 6, this flow can reach the speed of sound of the two-phase mixture 5 relatively quickly. As a result, in the one flow direction 15 in which the two-phase zone 6 is situated downstream of the cross-sectional constriction 7, significantly higher flow speeds can pass through the line segment 2 than in the opposite flow direction 16 in which the two-phase zone 6 is situated upstream of the cross-sectional constriction 7. The flow speed above which the control device 1_{II} reflects or inhibits in the opposite flow direction 16 can also be referred to as the inhibiting speed, whereas the flow speed still permitted in the flow direction 15 can be referred to as the maximum speed.

In fact, the control device 1_{II} according to FIG. 2 can essentially also be used to adjust the flow speed; in this case, different flow speeds can result for the two flow directions 15, 16. Preferably, however, a control device 1_{II} of this kind is used to permit pressure pulses in the one flow direction 15 and to stop or reflect them in the opposite flow direction 16. To this end, the mass percentage of the gas phase in the two-phase mixture 5 is set so that pressure pulses up to a permissible amplitude achieve a flow speed in the one flow direction 15 in the two-phase zone 6 that lies below the speed of sound of the two-phase mixture 5. Pressure pulses arriving in the opposite flow direction 16 once again lead to an entrainment of the two-phase mixture 5 into the cross-sectional constriction 7. The significantly increased flow speed in the cross-sectional constriction 7 causes the speed of sound of the two-phase mixture 5 there to be quickly reached so that the pressure pulse is stopped or reflected. In this connection, the amplitude of the pressure pulse arriving in the opposite flow direction 16 can also be lower than the amplitude of a pressure pulse arriving in the flow direction 15 and can pass through the line segment 2 in a quasi-uninhibited fashion.

By way of example, FIG. 3 shows a possible use of the control devices 1, 1_{I}, and 1_{II} according to the invention. According to FIG. 3, a fuel injection system 17 includes a fuel pump 18 that supplies a high-pressure line 20 with fuel via an intake line 19. From the high-pressure line 20, individual branch lines 21 lead to fuel injectors 22 that are each associated with a cylinder of an internal combustion engine that is not shown. Since all of the injectors 22 are connected to this same high-pressure line 20, this makes the current system a so-called “common rail” system.

In such a “common rail” system, the individual injectors 22 interact with one another via the common high-pressure line 20. For example, the opening and in particular the closing of one injector 22 causes a pressure wave that propagates via the branch line 21 into the high-pressure line 20 and via the remaining branch lines 21 to the other injectors 22. Since the individual injectors 22 are associated with different cylinders of the engine, they thus operate independently of one another, at any rate not simultaneously. Correspondingly, the above-mentioned pressure pulses result in undesirable pressure fluctuations in the injectors 22, which has a disadvantageous impact on the precision of the injection process, for example with regard to the injection quantity and/or the injection pressure. Moreover, the fuel pump 18, particularly when interacting with a pressure control valve 23, can produce pressure pulses that propagate via the supply line 19 to the high-pressure line 20 and can travel through it to the individual injectors 22.

With the aid of the control device 1 according to the present invention, it is now possible, within such a “common rail system” to achieve a pulsation-free system region that is symbolized by the dashed lines in FIG. 3 and labeled with the reference numeral 24. To this end, the supply line 19 downstream of the junction point of the pressure control valve 23 is provided with a control device 1_{I} embodied according to FIG. 1. As explained above, this control device 1_{I} can be operated so that it does not permit pressure pulses to pass through to the high-pressure line 20 or at least, only permits them to pass through to it in a powerfully damped fashion. The branch lines 21 are also each provided with control devices 1_{II} embodied according to FIG. 2. These devices, as explained above, can be operated so that they do in fact permit pressure pulses to pass through from the high-pressure line 20 to the respective injectors 22, but essentially inhibit or reflect pressure pulses oriented in the opposite flow direction. This essentially prevents the individual injectors 22 from interacting with one another via the high-pressure line 20. Pulse-like pressure fluctuations are likewise prevented from acting on the high-pressure line 20 via the supply line 9.

In addition to the particular use explained here for the control device 1 according to the present invention, there are also any number of other possible uses, for example in a power steering system of a motor vehicle. In such power steering systems, a damping hose or corresponding pulsation damper is used due to noise considerations. Control devices 1 according to the present invention can be used to damp and/or reflect pressure pulsations in order, for example, to replace such a damping hose or pulsation damper. Another possible use, for example, is in a brake system of a motor vehicle. Undesirable pressure pulsations can occur there, too, which can be damped or eliminated with the aid of the control device 1 according to the present invention.

### Reference Numeral List

1 control device
1_{I} control device according to FIG. 1
1_{II} control device according to FIG. 2
2 line segment
3 hydraulic line
4 generator apparatus
5 two-phase mixture
6 two-phase zone
7 cross-sectional constriction
8 bypass chamber
9 bypass
10 heating unit
11 gas phase
12 gas-permeable wall
13 control unit
13 control line
14 flow direction
16 opposite flow direction
17 fuel injection system
18 fuel pump
19 supply line
20 high-pressure line
21 branch line
22 injector
23 pressure control valve
24 pulsation-free system region

1-14. (canceled)

15. A device for controlling the flow speed of a fluid flow in a hydraulic line, the device comprising
a line segment that permits the fluid to flow through, and
an apparatus for generating a homogenous two-phase mixture in the fluid in the line segment.

16. The control device according to claim 15, further comprising a control unit embodied so that it sets the respective desired flow speed in the line segment by varying the mass percentage of the gas phase in the two-phase mixture.

17. The control device according to claim 15, wherein the line segment constitutes a definite cross-sectional constriction inside the hydraulic line and/or is equipped with such a constriction.

18. The control device according to claim 16, wherein the line segment constitutes a definite cross-sectional constriction inside the hydraulic line and/or is equipped with such a constriction.

19. The control device according to claim 17, wherein the generator apparatus generates the two-phase mixture in the region of the cross-sectional constriction.

20. The control device according to claim 18, wherein the generator apparatus generates the two-phase mixture in the region of the cross-sectional constriction.

21. The control device according to claim 17, wherein the line segment adjacent to the cross-sectional constriction comprises a two-phase zone with an enlarged cross section, and wherein the generator apparatus generates the two-phase mixture in the region of the two-phase zone.

22. The control device according to claim 18, wherein the line segment adjacent to the cross-sectional constriction comprises a two-phase zone with an enlarged cross section, and wherein the generator apparatus generates the two-phase mixture in the region of the two-phase zone.

23. The control device according to claim 21, wherein the two-phase zone and the cross-sectional constriction are matched to each other and the mass percentage of the gas phase in the two-phase mixture is set so that the fluid flow in a flow direction in which the two-phase zone is situated downstream of the cross-sectional constriction is able to flow through the line segment in an essentially unhindered fashion up to a predetermined or adjustable maximum speed, and in an opposite flow direction in which the two-phase zone is situated upstream of the cross-sectional constriction, the fluid flow is able to flow through the line segment in an essentially unhindered fashion up to a predetermined or adjustable inhibiting speed, which is lower than the maximum speed.

24. The control device according to claim 22, wherein the two-phase zone and the cross-sectional constriction are matched to each other and the mass percentage of the gas phase in the two-phase mixture is set so that the fluid flow in a flow direction in which the two-phase zone is situated downstream of the cross-sectional constriction is able to flow through the line segment in an essentially unhindered fashion up to a predetermined or adjustable maximum speed, and in an opposite flow direction in which the two-phase zone is situated upstream of the cross-sectional constriction, the fluid flow is able to flow through the line segment in an essentially unhindered fashion up to a predetermined or adjustable inhibiting speed, which is lower than the maximum speed.

25. The control device according to claim 15, wherein the generator apparatus introduces the gas phase into the fluid through a gas-permeable, in particular perforated or porous, wall of the line segment.

26. The control device according to claim 15, wherein the generator apparatus generates the gas phase from a partial flow diverted from the fluid flow.

27. The control device according to claim 26, the generator apparatus generates the gas phase by means of resistance heating and/or microwaves and/or ultrasound.

28. A method for controlling the flow speed of a fluid flow in a hydraulic line, the method comprising generating a homogenous two-phase mixture in the fluid in a line segment that permits the fluid to flow through.

29. The control method according to claim 28, further comprising adjusting the respective flow speed in the line segment by varying the mass percentage of the gas phase in the two-phase mixture.

30. The control method according to claim 28, further comprising generating the two-phase mixture in the region of a cross-sectional constriction with which the line segment is equipped or which the line segment constitutes within the hydraulic line.

31. The control method according to claim 29, further comprising generating the two-phase mixture in the region of a cross-sectional constriction with which the line segment is equipped or which the line segment constitutes within the hydraulic line.

32. The control method according to claim 28, the two-phase mixture is generated in the region of a two-phase zone that is situated in the line segment adjacent to a cross-sectional constriction and the cross-sectional constriction is constituted within the line segment or is constituted within the hydraulic line by the line segment.

33. The control method according to claim 29, the two-phase mixture is generated in the region of a two-phase zone that is situated in the line segment adjacent to a cross-sectional constriction and the cross-sectional constriction is constituted within the line segment or is constituted within the hydraulic line by the line segment.

34. The use of a control device according to claim 15, in a fuel injection system for a motor vehicle and/or in a power steering system for a motor vehicle and/or in a brake system for a motor vehicle to smooth pressure pulsations and/or to execute a direction-dependent reflection of pressure pulsations.
